(19) United States
(12) Patent Application Publication
(10) Pub. No.: US 2011/0261810 A1
(43) Pub. Date: Oct. 27, 2011

(54) NOTIFICATION METHOD AND GATEWAY FOR ACCESSING A VOICE OVER IP NETWORK

(75) Inventor: Nelly Trovel, Trebeurden (FR)

(73) Assignee: France Telecom, Paris (FR)

(21) Appl. No.: 13/141,815

(22) PCT Filed: Dec. 16, 2009
(86) PCT No.: PCT/FR2009/052561

§ 371 Date: Jun. 23, 2011

(30) Foreign Application Priority Data
Dec. 30, 2008 (FR) 0859121

(51) Int. Cl. H04L 12/66

(52) U.S. Cl. 370/352

(57) ABSTRACT

A method is implemented by an access gateway to a voice over IP network, connected to a plurality of terminals associated with one and the same telephonic identifier in said network, and comprises, on detection by said gateway of a switch to a connected or disconnected state of a call established between an external terminal and a terminal of said plurality of terminals, transmitting to at least one other terminal of said plurality of terminals a message comprising information relating to said switch of said call to said connected or disconnected state.

### BACKGROUND OF THE INVENTION

The present invention concerns the general field of telecommunications.

It relates more particularly to the keeping up to date of a local call journal of a telephonic terminal, placed behind an access gateway to a voice over IP (Internet Protocol) network, such as for example a domestic or residential gateway.

With the growing development of offerings from, voice over IP services, voice over IP network access gateways behind which it is possible to connect a plurality of terminals on distinct ports are known today.

These terminals may in particular be analog or DECT (Digital Enhanced Cordless Telephone) terminals, connected for example to an FXS (Foreign exchange Subscriber) port of the gateway, or as a variant voice over IP terminals (for example a high-definition voice over IP telephone), connected to a USB (Universal Serial Bus) port. Other connection interfaces, such as a WIFI (Wireless FIdelity) interface, can also be envisaged.

The terminals thus connected behind the gateway are generally associated. with one and the same telephonic identifier or number on the voice over IP network (for example, an SIP address). Thus, a single simultaneous telephonic communication between an external terminal and a terminal of the plurality of terminals connected to the gateway may be established. It will, however, be noted that an outgoing call may be initiated equally from any of the terminals connected to the gateway, just as an incoming call may be taken by any of the terminals connected, to the gateway.

Most terminals have only a local call journal, stored in a memory of the terminal, and which reflects the calls received and taken by this terminal via the gateway. It is therefore impossible by consulting the local call journal of such a terminal, to identify whether a call has been taken or initiated, for the same telephonic identifier, by another terminal connected to the gateway.

### SUMMARY AND SUMMARY OF THE INVENTION

The aim of the present invention is in particular to alleviate this drawback and to allow the synchronization of local call journals of diverse terminals connected to various ports of an access gateway to a voice over IP network.

To this end, it proposes a notification method implemented by an access gateway to a voice over IP network, connected to a plurality of terminals associated with one and the same telephonic identifier in this network. In accordance with the invention, the notification method comprises, on detection by the gateway of a switch to a connected or disconnected state of a call established between an external terminal and a terminal of this plurality of terminals, a step of transmission to at least one other terminal of this plurality of terminals of a message comprising information relating to the switch of the call to the connected or disconnected state.

Correlatively, the invention is also aimed at an access gateway to a voice over IP network connected to a plurality of terminals associated with one and the same telephonic identifier in this network, this gateway comprising:
means for detecting a switch to a connected or disconnected state of a call established between an external terminal and a terminal of the plurality of terminals connected to the gateway; and
means, activated on detection of the switch, for transmitting to at least one other terminal of this plurality of terminals, a message comprising information relating to the switch of the call to the connected or disconnected state.

The information received from the gateway can comprise in particular at least one parameter indicating the state of the call (namely whether this call is in a connected or disconnected state) and a parameter indicating whether said call is an incoming or outgoing call.

Thus, the invention makes it possible for the terminals connected behind an access gateway to a voice over IP network and corresponding to one and the same telephonic identifier, to be kept informed of the calls sent or taken by each of them.

Preferably, a message is dispatched by the gateway to the set of terminals connected to this gateway (with the exception, however, of the terminal to which the call is relevant). In this way, at each instant, the set of terminals situated behind the gateway possess the same information relating to the calls sent or received via the gateway by each of them.

The implementation of the invention is simple. It requires only few modifications at the level of the existing equipment (gateway and terminals), since it relies advantageously on the gateway for access to the voice over IP network which, on account of its function, already possesses the contexts of the calls which are sent or received by way thereof.

Furthermore, the gateway being capable of identifying the terminal which has taken or sent the call, it can advantageously dispatch a notification message just to the other terminals, so as to avoid doublets at the level of the terminal that took or sent the call.

As a variant, the gateway can also dispatch a notification message to this terminal, so as to allow for example verification of its call journal, or synchronization of the latter in the case of malfunction.

Moreover, the notification message being dispatched by the gateway as soon as a switch to a connected or disconnected state of a call (whether it be incoming or outgoing) is detected for one of the terminals, the invention does not require any additional memory resources at the gateway level.

It will also be noted that the invention minimizes in an advantageous manner the exchanging of messages between the gateway and the terminals. Indeed, a message is dispatched by the gateway to the terminals only on detection of a change of state of a call (switch to the connected or disconnected, state). Thus, the invention does not require any periodic polling by the terminals of the gateway so as to be informed of the calls received or sent by the other terminals. The invention relying on a unidirectional link between the gateway and the terminals, the resources of the gateway are safeguarded and the invention does not give rise to any needless traffic between the gateway and the terminals.

According to a second aspect, the invention is also aimed at a method for synchronizing a local call journal of a first terminal connected to an access gateway to a. voice over IP network, this synchronization method comprising:
on detection by the gateway of a switch to a connected or disconnected state of a call established between an external terminal and a second terminal connected, to this gateway and associated with one and the same telephonic identifier in the network as the first terminal, a step of transmission by the gateway to the first terminal of a message comprising information relating to the switch of the call to a connected or disconnected state; and
a step of updating the call journal of the first terminal with the aid of this information.

Correlatively, the invention is also aimed, at a system comprising an access gateway to a voice over IP network according to the invention, connected to a plurality of terminals associated with one and the same telephonic identifier in the network, each terminal of this plurality of terminals being suitable for updating a local call journal of this terminal with the aid of information received from the gateway and relating to a switch to a connected or disconnected state of a call established between an external terminal and another terminal of the plurality of terminals.

Thus, by consulting the local call journal of one or the other of the terminals connected to the access gateway, it is possible to identify the set of calls received or sent at the level of the terminals. At one and the same instant, each telephone in fact exhibits a similar call journal. Whichever journal is consulted, an up-to-date view of the calls sent and received by the terminals by way of the gateway is thus available.

In a particular embodiment, the various steps of the notification method are determined by instructions of computers programs.

Consequently, the invention is also aimed at a computer program on. an information medium, this program being able to be implemented in an access gateway to a voice over IP network or more generally in a computer, this program comprising instructions suited to the implementation of the steps of a notification method such as is described hereinabove.

This program can use any programming language, and be in the form of source code, object code, or of code intermediate between source code and object code, such as in a partially compiled form, or in any other desirable form.

The invention is also aimed at an information medium readable by a computer, and comprising instructions of a computer program such as is mentioned hereinabove.

The information medium may be any entity or device capable of storing the program. For example, the medium can comprise a storage means, such as a ROM, for example a CD ROM or a microelectronic circuit ROM, or else a magnetic recording means, for example a diskette (floppy disk) or a hard disk.

Moreover, the information medium may be a transmissible medium such as an electrical or optical signal, which may be conveyed via an electrical or optical cable, by radio or by other means. The program according to the invention may in particular be downloaded from a network of Internet type.

Alternatively, the information medium may be an integrated circuit into which the program is incorporated, the circuit being adapted for executing or to be used in the execution of the method in question.

The invention is also aimed at a signal in accordance with the V23 protocol specified by the ITU-T, comprising a message and suitable for being dispatched by an access gateway to a voice over IP network to a first terminal connected to said gateway. In accordance with the invention, the message comprises at least one parameter representative of a state of connection or of disconnection of a call established between an external terminal and a second terminal connected to the gateway and associated with one and the same telephonic identifier in the network as the first terminal.

In a particular embodiment, the message furthermore comprises a parameter indicating whether the call is an incoming or outgoing call.

The invention thus advantageously relies on an already existing communication interface between the gateway and certain terminals, such as analog or DECT terminals in particular, namely the V23 signaling protocol. For more information relating to this protocol, the person skilled in the art is invited to refer to the document entitled “600/1200 baud modem standardized for use in the general switched telephone network”, CCITT Recommendation V23 (1988).

Finally the invention is correlatively aimed at a terminal able to be connected to an access gateway to a voice over IP network, connected to a plurality of terminals associated with one and the same telephonic identifier in said network, characterized in that it comprises means for receiving a message originating from said, gateway, said message comprising information relating to the switch of a call established between an external terminal and a terminal of said plurality of terminals, to a connected, or disconnected, state.

Advantageously, said message is coded in the V23 format as described above.

### BRIEF DESCRIPTION OF AN EMBODIMENT

Other characteristics and advantages of the present invention will emerge from the description given hereinbelow, with reference to the appended drawings which illustrate an exemplary embodiment thereof devoid of any limiting character:

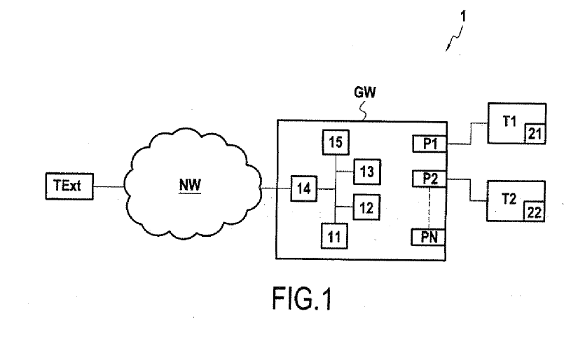

FIG. 1 represents, in its environment, a system and a gateway in accordance with the invention, in a particular embodiment;

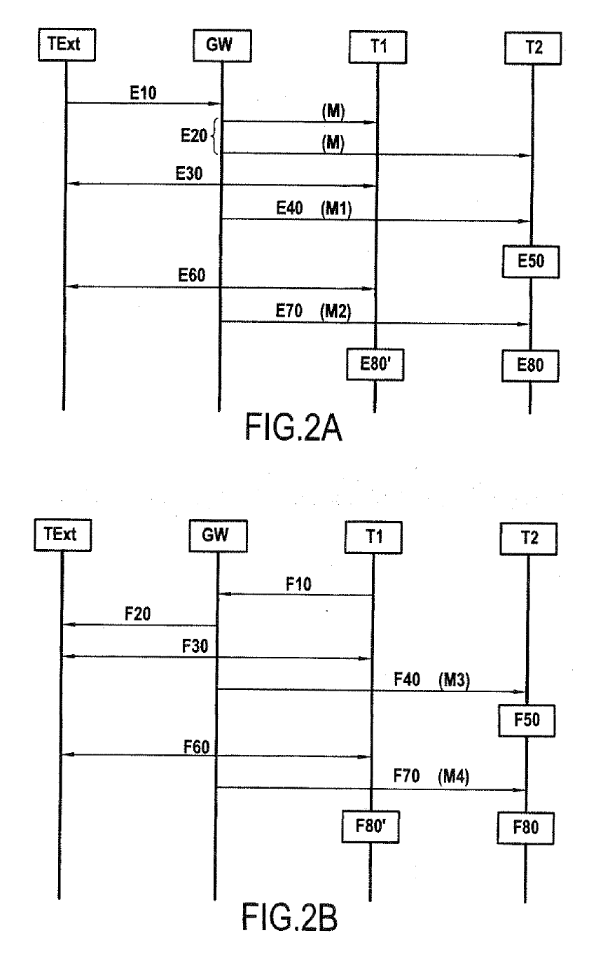

FIG. 2A represents, in a particular embodiment, the main steps of the transmission and synchronization methods according to the invention, when they are implemented by the system and the gateway represented in FIG. 1, for an incoming call originating from an external terminal and taken by a terminal T1 of the system according to the invention and

FIG. 2B represents, in a particular embodiment, the main steps of the transmission and synchronization methods according to the invention, when they are implemented by the system and the gateway represented, in FIG. 1 for an outgoing call sent by a terminal T1 of the system according to the invention destined for an external terminal.

### DETAILED DESCRIPTION OF AN EMBODIMENT

FIG. 1 represents, in its environment, a system 1 in accordance with the invention, in a particular embodiment.

The system 1 comprises an access gateway GW to a network NW offering a voice over IP service, in accordance with the invention.

The access gateway GW is equipped with a plurality of connection ports, P1, P2, . . . , PN, to which it is possible to connect a plurality of terminals. In the example envisaged in FIG. 1, a terminal T1 and a terminal T2 are connected respectively to the ports P1 and P2 of the gateway.

The pores P1, P2, . . . PN of the gateway GW may be of various types. They may for example be FXS, USB ports, etc. Furthermore, it is also possible to connect terminals to the gateway GW via a wireless interface, such as for example a WIFI interface, by way in particular of a dongle connected to a USE port of the gateway.

Thus, the terminals that can be connected to the gateway GW may also be of various types. They may for example be telephonic terminals of analog or DECT type, high-definition voice over IP telephonic terminals, or else terminals of PC (Personal Computer) type. Of course, other terminals allowing a user to send or to receive a call may be envisaged in the context of the invention.

In the example described here, the terminals T1 and T2 are terminals of analog or DECT type, and the ports P1 and P2 of the gateway to which they are connected are FXS ports known per se. The signaling messages exchanged between the terminals T1 and T2 on the one hand and the gateway GW on the other hand are assumed here to comply with the V23 protocol specified by the ITU-T and known to the person skilled in the art. Such a protocol, allows in particular the gateway to dispatch messages to the terminals T1 and T2 although the latter are in on-hook mode, that is to say they do not participate in any call.

These assumptions are, however, not limiting, other configurations of terminals may be considered, through the adaptation of the protocols for communication between the terminals and the gateway. Furthermore, a more significant number of terminals connected to the gateway could be considered.

In the example envisaged here, it is assumed that the access gateway GW is associated with a single telephonic identifier ID, also commonly called a voice over IP number. One speaks of a “single-line” voice over IP service. Such an identifier ID is for example an SIP address allocated to the gateway GW.

The terminals connected to the gateway GW are thus, in the case envisaged here, associated with the same telephonic identifier ID. In this way, a call intended for the telephonic identifier ID is signaled by the gateway to the two terminals T1 and 12, and may be taken equally by the terminal T1 or the terminal T2. It will be noted, furthermore, that because the terminals T1 and T2 are associated, with the same telephonic identifier ID:
a single simultaneous telephonic communication between an external terminal (typically the terminal TExt) and one of the terminals T1 or T2 connected to the gateway may be established; and
an outgoing call may be initiated equally from any of the terminals T1 or T2 connected to the gateway GW.

However, the invention can also be adapted, without major difficulty for the person skilled in the art, to a multi-line voice over IP service offered by way of the gateway and for which a plurality of telephonic identifiers would be associated with the gateway GW. In this case, the invention is applied independently to each “line” associated with a distinct telephonic identifier.

Here, the gateway GW has the hardware architecture of a computer. It comprises in particular a processor 11, a random access memory 12, a read, only memory 13 and means 14 of communication with the network NW.

The gateway GW furthermore comprises a call automaton 15, suitable for managing the calls sent (respectively received) by the terminals connected to the gateway to (respectively from) an external terminal, such as for example the telephonic terminal TExt, itself connected to the network NW. Such an automaton with which the gateway GW is equipped is known to the person skilled in the art and will not be detailed further here.

The read only memory 13 of the gateway GW comprises a computerized, program suitable for executing the main steps of the notification method according to the invention, represented in FIGS. 2A and 2B described subsequently.

In the example described here, each terminal T1 and T2 has a screen (not represented in FIG. 1) and a local call journal (referenced respectively by 21 and 22 in FIG. 1).

In a known manner, a local call journal is a database (or fiat file) stored, preferably, in a nonvolatile memory of the terminal, and cataloguing a list of calls. Various fields are conventionally associated with a call in this database, such as in particular, an identifier of the called or calling terminal, the date and the time at which the call was presented and optionally taken or established, the duration of the call, etc.

We shall, now describe, with reference to FIGS. 2A and 2B, the main steps of the notification method and of the synchronization method according to the invention, in a particular embodiment, when they are implemented respectively by the gateway GW and the system 1 represented in FIG. 1.

Two typical cases are envisaged, here to illustrate the manner in which these methods proceed:

1) a call is sent by the terminal TExt destined for the telephonic identifier ID, and is taken by the term, in a T1 connected to the gateway GW (case represented in FIG. 2A);

2) a call is sent by the terminal T1 connected to the gateway GW destined for the terminal TExt (case represented in FIG. 2B).

With reference to FIG. 2A, the terminal TExt sends a call destined for the telephonic identifier ID associated with the gateway GW (step E10).

This call is forwarded to the gateway GW by the network NW, according to means known to the person skilled in the art.

On receipt of this call, the gateway dispatches a call message M to the terminals T1 and T2 to signal the call (step E20). In the example described here, the message M complies with the V23 signaling protocol and is associated with a ringing sequence. Thus, on receipt of the message M, the terminals T1 and T2 ring.

It is assumed here that a user puts the terminal T1 off-hook so as to take the call. The connection between the terminal TExt and the terminal T1 is then established and a context relating to this call is created by the automaton 15 of the gateway GW, according to known means that are not detailed further here (step E30). This context is stored, in the random, access memory 12 of the gateway GW.

The call context thus created comprises the parameters of the call and in particular an indication according to which the call between TExt and T1 is in a “connected” state. It furthermore indicates that the call has been taken by the terminal connected to the port P1.

The connection between the terminal TExt and the terminal T1 being established, the terminal T2 ceases ringing (i.e. the gateway GW ceases sending the message M destined for the terminals T1 and T2).

The local call journal 22 of the terminal 12 is then updated with a new entry mentioning in particular that the call arising from TExt has not been taken by the terminal T2 and indicating the time at which this call was received. For example, the local call journal 22 is enriched with the following entry E2:

E2=“incoming call from TExt, received at 12 h: not answered”.

In a similar manner, the local call journal 21 of T1 is enriched with a new entry, mentioning in particular that the call arising from TExt has been taken by the terminal T1 and indicating the time at which this call was taken. For example, the local call journal 21 is enriched with the following entry E1:

E1=“incoming call from TExt, received at 12 h: connected”.

On detection of the connected state of the call established between the terminal TExt and the terminal T1, the gateway GW transmits a notification message M1 to the terminal T2 to signal, to it the switch to the connected state of the call (step E40).

The gateway GW identifies the terminals to which to transmit the message M1 by consulting the call context created in the course of step E30. More precisely, it identifies, with the aid of this context, the ports to which to dispatch the message M1 (namely here all the terminals connected to the gateway except for the terminal T1 that took the call). The nature of the thus identified ports allows it to select the signalling protocol to be used to dispatch this message to the terminals concerned. This message is transported in a signal in accordance with the invention.

Thus, in the example envisaged, here, the gateway GW determines that the message M1 must be dispatched, in accordance with the V23 protocol, to the terminal T2 connected, to the port P2. To this end, the message M1 takes for example the form of a notification message such as proposed in the V23 protocol, dispatched according to a mode of transmission termed “in on-hook phase” and not associated with a ringing sequence. The message M1 furthermore comprises the following parameters:
date and time of the call (parameter coded by the hexadecimal value 01 H);
identity of the terminal TExt (parameter coded by the hexadecimal value 02 H);
state of the call (i.e. connected or disconnected); and
type of the call (i.e. incoming or outgoing).

In the typical case envisaged here, the call state parameter takes the value “connected” and the call type parameter takes the value “incoming”.

It will be noted that the V23 protocol in its current form does not make it possible to include in. a notification message the “call state” and “call type” parameters. Consequently, an appropriate coding will have to be defined beforehand with the ITU so that these parameters are recognized by the terminals in accordance with, the V23 protocol. For example, such a coding could associate the hexadecimal value 3 DH with the “call state” parameter and the hexadecimal value 3 EH with the “call type” parameter. Of course, some other coding could be envisaged.

On receipt of the message M1, the terminal T2 updates its local call journal 22, with the information contained, in this message M1 (step E50). In particular, it updates the entry E2 of the journal 22 corresponding to the call received from the terminal TExt by indicating that the call is in a connected state. The entry E2 of the journal 22 becomes for example:

E2=“incoming call from TExt, received at 12 h: connected”.

It is now assumed that the user of the terminal T1 puts his terminal on-hook and terminates the call with the terminal TExt (step E60). On detection of this on-hook status on the port P1, the context of the call is updated by the call automaton 15 of the gateway GW, so as to indicate that the call is now in a disconnected state on the port P1.

On detection of the switch to the disconnected state of the call, the gateway GW also transmits to the terminal T2, connected to the port P2, a notification message M2 so as to signal to it the switch to the disconnected state of the call (step E70).

In a manner similar to step E40, the gateway GW identifies the terminals to which to transmit the message M2 by consulting the call context. More precisely, it identifies with the aid of this context, the ports to which to dispatch the message M2 (namely here all the terminals connected to the gateway except for the terminal T1). The nature of the thus identified ports allows it to select the signaling protocol to be used to dispatch this message toward the terminals concerned. This message is transported in a signal in accordance with the invention.

Thus, in the example envisaged here, the gateway GW determines that the message M2 must be dispatched in accordance with, the V23 protocol to the terminal T2 connected to the port P2. To this end, the message M2 takes for example the form of a notification message such as proposed previously for the message M1 and in which the call state and call type parameters have the respective values “disconnected” and “incoming”.

On receipt of the message M2, the terminal T2 updates its local call journal 22, with the information contained in this message M2 (step E80). In particular, it updates the entry E2 of the journal 22 corresponding to the call received from the terminal TExt by indicating that the call is in a disconnected state. The entry E2 of the journal 22 thus becomes for example:

E2=“incoming call from TExt, received at 12 h: disconnected”.

Furthermore, the terminal T2 evaluates the duration of the call received and supplements the entry E2 with this duration.

As a variant, this duration may be evaluated by the call automaton 15 of the gateway GW with the aid of the information contained in the context of the call, and transmitted in the message M2 to the terminal T2, in a parameter whose coding will have been declared beforehand in an appropriate manner with the ITU.

On completion of step E80, an application of API (Application Programming Interface) type of the terminal T2, known per se, reads the information relating to the entry E2 in the call journal 22 so as to display said information on the screen of the terminal T2. Thus, the following information appears on the screen of the terminal 22:

“incoming call from TExt, received at 12 h, duration 2 min”.

In a similar manner, the Local, call journal 21 of the terminal T1 is updated, subsequent to the on-hook status of the terminal T1 (step E80′), and an API application of the terminal T1 reads the information relating to the entry E1 in the call journal 21 so as to display said information on the screen of the terminal T1. Thus, the following information appears on the screen of the terminal 21:

“incoming call from TExt, received at 12 h, duration 2 min”.

We shall now describe, with reference to FIG. 2B, an example in which the terminal T1 is the origin of a call destined for the terminal TExt (step F10).

This call is transmitted by the gateway GW and via the network NW up to the terminal TExt, according to means known to the person skilled in the art (step F20).

It is then assumed that a. user puts the terminal TExt off-hook so as to take the call. The connection between the terminal TExt and the terminal T1 is thus established and a context relating to this call is created, by the automaton 15 of the gateway GW (step F30). The call context thus created comprises the parameters of the call and in particular an indication according to which the call between TExt and T1 is in a “connected” state. It furthermore indicates that the call was sent by the terminal connected to the port P1.

Subsequent to this connection, the local call journal 21 of T1 is enriched with a new entry, mentioning in particular that the call sent destined for TExt is in a connected state and indicating the time at which this call was taken. For example, the local call journal 21 is enriched with the following entry E1′:

E1′=“outgoing call to TExt, sent at 12 h: connected”.

On detection of the connected state of the call established between the terminal TExt and the terminal T1, the gateway GW transmits a notification message M3 to the terminal T2 to signal to it the switch to the connected state of the call (step F40).

As described previously with reference to FIG. 2A, the gateway GW identifies the terminals to which to dispatch the message M3, by consulting the call context established in the course of step F30.

Thus, in the example envisaged here, the gateway GW determines that the message M3 must be dispatched in accordance with the V23 protocol to the terminal T2 connected to the port P2. This message M3 is similar to the message M1 described previously, in which the call state and call type parameters take the values “connected” and “outgoing” respectively.

On receipt of the message M3, the terminal T2 updates its local call journal 22, with the information contained in this message (step F50). In particular, it enriches its call journal 22 with a new entry E2′ corresponding to the call sent by the terminal T1.

The entry E2′ of the journal 22 is for example:

E2′=“outgoing call to TExt, sent at 12 h: connected”.

It is now assumed that the user of the terminal T1 puts his terminal on-hook and terminates the call with the terminal TExt (step F60). On detection of the on-hook status of the terminal T1, the context of the call is updated by the call automaton 15 of the gateway GW, so as to indicate that the call is now in a disconnected state on the port P1.

On detection of the switch to the disconnected state of the call, the gateway GW also transmits to the terminal T2 connected to the port P2, a notification message M4 to signal to it the switch to the disconnected state of the call (step F70). The message M4 is similar to the message M2 described previously in which the call state and call type parameters take the values “disconnected” and “outgoing” respectively.

On receipt of the message M4, the terminal T2 updates its local call journal 22, with the information contained, in this message (step F80). In particular, it updates the entry E2′ of the journal 22 corresponding to the call sent to the terminal TExt, by indicating that the call is now in a disconnected state. The entry E2′ of the journal 22 thus becomes for example:

E2′=“outgoing call to TExt, sent at 12 h: disconnected”.

Furthermore, the terminal T2 evaluates the duration of the call received, and supplements the entry E2′ with this duration. As a variant, this duration may be evaluated by the call automaton 15 of the gateway GW and transmitted in the message M4.

On completion of step F80, the previously described API application of the terminal T2 reads the information relating to the entry E2′ in the call journal 22 so as to display said information on the screen of the terminal T2. Thus, the following information appears on the screen of the terminal 22:

“outgoing call to TExt, sent at 12 h, duration 2 min”.

In a similar manner, the local call journal 21 of the terminal T1 is updated, subsequent to the on-hook status of the terminal T1 (step F80′), and the API application of the terminal T1 reads the information relating to the entry E1′ in the call journal 21 so as to display said information on the screen of the terminal T1. Thus, the following information appears on the screen of the terminal 21:

“outgoing call to TExt, sent at 12 h, duration 2 min”.

The examples envisaged here rely on signaling messages exchanged between the gateway and the terminals in accordance with the V23 protocol. This assumption is, however, not limiting. Other messages can of course be envisaged, in compliance with other standardized protocols or proprietary protocols.

1. A notification method implemented by an access gateway to a voice over IP network, connected to a plurality of terminals associated with one and the same telephonic identifier in said network, said method comprising:
on detection by said gateway of a switch to a connected or disconnected state of a call established between an external terminal and a terminal of said plurality of terminals, transmitting to at least one other terminal said plurality of terminals of a message comprising information relating to said switch of said call to said connected or disconnected state.

2. The notification method as claimed in claim 1, wherein said information comprises at least one parameter indicating said state of said call and a parameter indicating whether said call is an incoming or outgoing call.

3. An access gateway to a voice over IP network, connected to a plurality of terminals associated with one and the same telephonic identifier in said network, said gateway comprising:
a detector for detecting a switch to a connected or disconnected state of a call established between an external terminal and a terminal of said plurality of terminals; and
a transmitter, activated on detection of said switch, for transmitting to at least one other terminal of said plurality of terminals, a message comprising information relating to said switch of said call to said connected or disconnected state.

4. A method for synchronizing a local call journal of a first terminal connected to an access gateway to a voice over IP network, said synchronization method comprising:
on detection by said gateway of a switch to a connected or disconnected state of a call established between an external terminal and a second terminal connected to said gateway and associated with one and the same telephonic identifier in said network as said first terminal, transmitting by said gateway to said first terminal a message comprising information relating to said switch of said call to said connected or disconnected state; and
updating said call journal of said first terminal with the aid of said information.

5. A system comprising;
an access gateway to a voice over IP network as claimed in claim 3, connected to
a plurality of terminals associated with one and the same telephonic identifier in said network, each terminal of said plurality of terminals being suitable for updating a local call journal of this terminal with the aid of information received from said gateway and relating to a switch to a connected or disconnected state of a call established between an external terminal and another terminal of the plurality of terminals.

6. A non-transitory computer program product comprising instructions for the execution of the steps of the notification method as claimed in claim 1 when said program is executed by a computer processor.

7. A recording medium readable by a computer on which is recorded a non-transitory computer program product comprising instructions for the execution of the steps of the notification method as claimed in claim 1.

8. A method for generating a signal in accordance with the V23 protocol specified by the ITU-T, comprising:
generating a message, the signal being suitable for dispatch, by an access gateway to a voice over IP network to a first terminal connected to said gateway, said message comprising at least one parameter representative of a state of connection or of disconnection of a call established between an external terminal and a second terminal connected to said gateway and associated with one and the same telephonic identifier in said network as said first terminal.

9. The method for generating the signal as claimed in claim 8, wherein the message further comprises a parameter indicating whether said call is an incoming or outgoing call.

10. A terminal connectable to an access gateway to a voice over IP network, connected to a plurality of terminals associated with one and the same telephonic identifier in said network, comprising:
a receiver for receiving a message originating from said gateway, said message comprising information relating to the switch of a call established between an external terminal and a terminal of said plurality of terminals, to a connected or disconnected state.

11. The terminal as claimed in claim 10, wherein said message corresponds to the message transported in the signal in accordance with the V23 protocol specified by the ITU-T, comprising a message and suitable for being dispatched, by an access gateway to a voice over IP network to a first terminal connected to said gateway, said message comprising at least one parameter representative of a state of connection or of disconnection of a call established between an external terminal and a second terminal connected to said gateway and associated with one and the same telephonic identifier in said network as said first terminal.

12. A method for generating a signal in accordance with the signaling protocol selected depending on the nature of a port identified by an access gateway at a voice over IP network, comprising:
generating a message, the signal being suitable for dispatch, by said gateway to a first terminal connected to said gateway via the port identified, said message comprising at least one parameter representative of a state of connection or of disconnection of a call established between an external terminal and a second terminal connected to said gateway and associated with one and the same telephonic identifier in said network as said first terminal.

13. The method for generating a signal as claimed in claim 12, wherein the message further comprises a parameter indicating whether said call is an incoming or outgoing call.

14. The terminal as claimed in claim 10, wherein said message corresponds to the message transported in the signal in accordance with the signaling protocol selected depending on the nature of a port identified by an access gateway at a voice over IP network, comprising a message and suitable for being dispatched, by said gateway to a first terminal connected to said gateway via the port identified, said message comprising at least one parameter representative of a state of connection or of disconnection of a call established between an external terminal and a second terminal connected to said gateway and associated with one and the same telephonic identifier in said network as said first terminal

15. The terminal as claimed in claim 10, wherein said message corresponds to the message transported in the signal, wherein the message comprises a parameter indicating whether said call is an incoming or outgoing call.
